(19) United States
(12) Patent Application Publication
(10) Pub. No.: US 2004/0207109 A1
(43) Pub. Date: Oct. 21, 2004

(54) Method for the manufacture of components in the form of a laminate of fiber and plastic

(76) Inventor: Dietmar Muller, Herford (DE)

Correspondence Address: FULBRIGHT & JAWORSKI, LLP, 666 FIFTH AVE, NEW YORK, NY, 10103-3198, US

(21) Appl. No.: 10/417,421

(22) Filed: Apr. 16, 2003

(51) Int. Cl. B29C 70/52

(52) U.S. Cl. 264/136; 264/137; 264/138; 156/166

(57) ABSTRACT

The method serves for the manufacture of components in the form of a fiber-and-plastic laminate (FKV) in which fibers (12) are drawn from at least one reel (10), carried through a plastic-impregnating system (16, 18, 20) and wound onto a core (36). The laminate wound onto the core (36) is cut, removed from the core, and placed in a mold (40).

The invention relates to a method for the manufacture of components in the form of a fiber reinforced plastic laminate in which fibers are drawn from at least one reel, carried through a resin-impregnating system and wound onto a core.

Fiber reinforced plastic (FRP) laminates permit the manufacture of workpieces with numerous advantages, including low weight, high strength, good vibration absorption and acceptable manufacturing costs.

In addition to the methods that are largely performed manually, in which dry or pre-impregnated layers, tissues and webs are laid in a mold, and after the mold is closed and filled with synthetic resins they are impregnated, there are other methods as well, in which fibers or rovings are drawn from one or more reels, pass through an impregnating system and are wound on a mold, e.g., a cylindrical core. These methods are called Filament Winding methods.

Those known methods involve a large amount of manual work and accordingly are cost-intensive. If the fibers are in the form of semi-finished products, i.e., tissues, webs, etc., an additional intermediate step in the production is necessary, which as a rule must even be made by an outside supplier.

Those of the above-named methods, in which fibers are drawn directly from reels and wound onto a core, can be performed within one and the same factory and even virtually entirely automatically. They can be employed, however, only for the production of rods, tubes, cylinders, containers, etc.

The invention is addressed to the problem of creating a method of the above kind which will permit economical manufacture of components of largely any shape.

This problem is solved by the invention in a method of the above kind by the fact that the laminate wound on the core is cut, taken from the core and placed in or onto a mold.

With the present invention the advantages of the conventional filament winding method are used for the production of a laminate of virtually any size, which permits the production of articles of any size, but especially large and very large articles in the form of FRP laminates.

While in conventional methods the fibers must be laid in the mold as strips, for example, or layers of fabric of given width, the invention offers the possibility of fashioning the laminate taken from the core according to need and placing it into the form in a single operation. The thickness of the fiber layer is the same in the entire mold, while in conventional methods overlapping is usually unavoidable. The thicknesses of the laminate layers can be adapted to requirements.

In what follows, preferred embodiments of the invention are further explained in connection with the attached drawing.

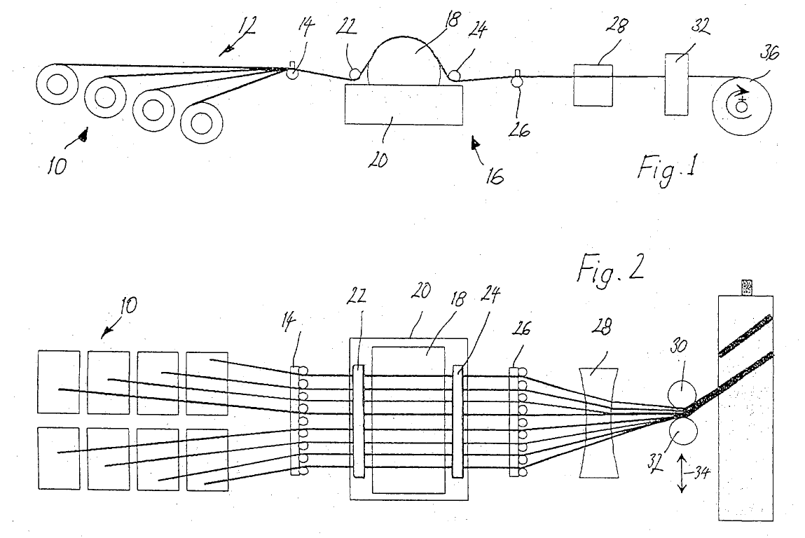

FIG. 1 shows the method for the production of a laminate on a core, in a schematic side view;

FIG. 2 is a top plan view of FIG. 1;

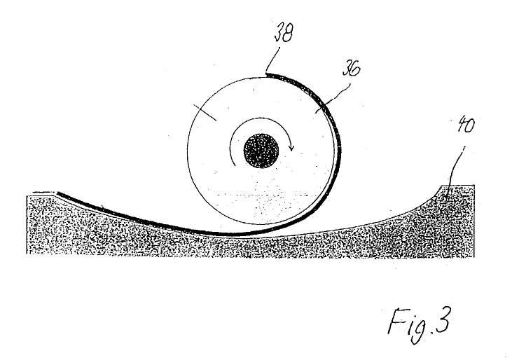

FIG. 3 shows the insertion of the laminate into the mold;

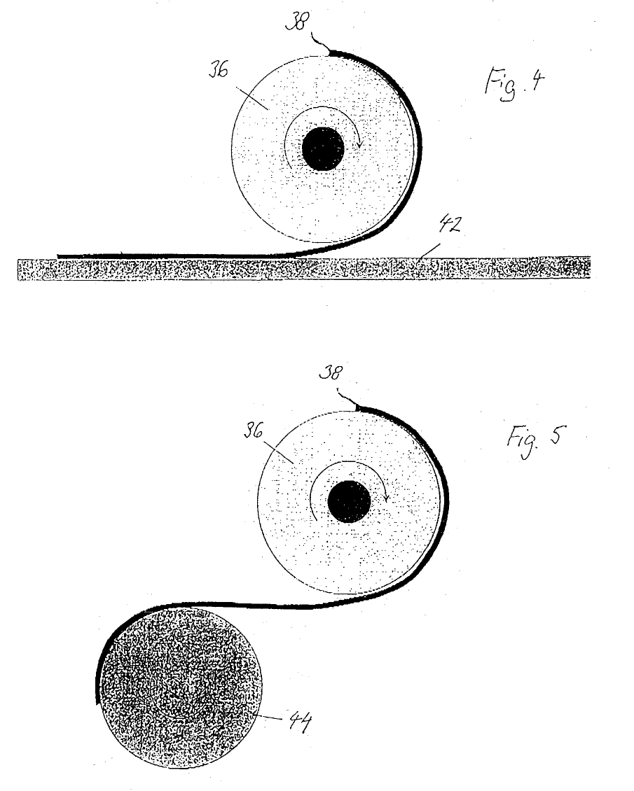

FIG. 4 shows the laying of the laminate on a table;

FIG. 5 shows the transfer of the laminate to another core.

FIGS. 1 and 2 show eight reels 10, from each of which a thread or yarn is drawn. The threads run over a guide strip 14 equipped with guide pins and then arrive at an impregnation station 16.

Here the threads 12 run parallel to one another over a rotatory impregnating drum 18 the lower part of which is immersed in an impregnating bath 20. The threads are pressed against the upper part of the impregnating drum 18 by means of cylindrical or rod-like hold-downs 22, 24.

Then the threads run on over a guiding staff 26 provided with pins, and from there they pass over a guiding beam 28 into the outlet guide means 30, 32.

The outlet guide means 30, 32, move up and down in the sense of the double arrow 34 in FIG. 2 in front of a revolving core, so that the fiber strand of the threads 12 is wound back and forth onto the core 36. This process just described is called a filament winding process and is known as such. It is used for the production of tubes, hollow shafts, containers and the like.

According to the present invention the wound laminate is severed along a generatrix 38 of the core and either laid directly into a mold 40, as shown in FIG. 3, or first delivered for further treatment, as for example for cutting to the shape of the mold to be used. According to the invention, the filament winding method is used to produce a mat which can be used directly as a preimpregnated semi-finished product which is cut to match the geometry of the mold into which the semi-finished product is placed, so that the time-consuming placement of woven strips into the mold can be eliminated.

The method of the invention can be used for the production of large parts, for example in boat construction or also in the construction of the vanes of windmills, aircraft wings, or any other parts that can be made from FRP laminates (boards, etc.).

The cutting of the laminates on the core can be performed with a knife, without any special apparatus. For example, the core can have a guiding slot along a generatrix or slot or depressions along which a knife can be guided.

To prevent the laminate from falling off the core when it is cut, various clamping devices can be provided, e.g., clamping bars, magnetic retainers, pins or other devices installed in the core. The core can also be designed as a vacuum drum enabling the laminate to be pulled onto it while it is being fashioned. Then see FIGS. 4 and 5.

While in FIG. 3 the laminate removed from the core is placed directly into a mold 40, FIGS. 4 and 5 show solutions for the time between the production of the laminate on the core and the final use of the laminate. Thus the laminate in FIG. 4 is unwound from the core, not into the mold, but onto a table 42 on which the laminate can be fashioned, for example. Instead of the table 42, a carrier plate can be used on which the laminate can cut up to size for example. Instead of the table 42, a carrier plate can be used on which the laminate can be held temporarily and transported.

FIG. 4 shows how the laminate is wound from core 36 onto a second core 44 of smaller diameter, which can likewise serve transporting or holding purposes.

Fibers for making the laminate can be carbon fibers, glass fibers, aramid fibers, or also natural fibers or metal fibers. These can be used alternatively or also in mixture. The impregnation can be performed, for example, with epoxy resin, polyester, phenolic resin or thermoplastic materials.

The core on which the laminate is wound does not have to be cylindrical in every case. A tapering core or a barrel-shaped core or a waisted core can be used. Thus greater wall thicknesses will result in areas of lesser diameter. Thus the laminate can be provided selectively with areas of different wall thicknesses.

1-7. (cancel)

8. A method for the manufacture of a fiber-and-plastic laminate (FKV) component comprising
drawing fibers from at least one reel;
carrying the drawn fibers through a synthetic resin impregnating system, and winding the resultant laminate onto a core;
cutting open the laminate;
removing the laminate from the core; and
placing the laminate in a mold to form the component.

9. A method according to claim 8, wherein the laminate is cut to pattern after removal from the core.

10. A method according to claim 8, wherein the laminate is cut to pattern on the core.

11. A method according to claim 8, wherein the fibers in the laminate are selected from the group consisting of carbon, glass, aramid, polyester, natural and metal.

12. A method according to claim 8, wherein the fibers are impregnated with at least one of an epoxy resin, polyester, phenolic resin and a thermoplastic material.

13. A method according to claim 8, wherein the core is cylindrical.

14. A method according to claim 8, wherein the core has a diameter that varies over its length.
